(19) United States
(12) Patent Application Publication
(10) Pub. No.: US 2016/0192201 A1
(43) Pub. Date: Jun. 30, 2016

(54) TECHNIQUES FOR USING A FIRST RADIO TO RESERVE A SHARED RADIO FREQUENCY SPECTRUM FOR A SECOND RADIO

(71) Applicant: QUALCOMM Incorporated, San Diego, CA (US)

(72) Inventor: Jibing Wang, San Diego, CA (US)

(21) Appl. No.: 14/586,061

(22) Filed: Dec. 30, 2014

(51) Int. Cl. H04W 16/14; H04W 72/08

(52) U.S. Cl. CPC H04W 16/14; H04W 72/082

(57) ABSTRACT

Techniques are described for wireless communication. A first radio of a user equipment (UE) may receive timing information relating to a transmission of system information over a shared radio frequency spectrum. The first radio may transmit a signal to reserve resources of the shared radio frequency spectrum based at least in part on the timing information. A second radio of the UE may monitor the resources of the shared radio frequency spectrum for the system information. The monitoring may be independent of a successful reservation of the resources of the shared radio frequency spectrum by the first radio.

### BACKGROUND

1. Field of the Disclosure

The present disclosure, for example, relates to wireless communication systems, and more particularly to techniques for using a first radio (e.g., a wireless local area network (WLAN) radio) to reserve a shared radio frequency spectrum for a second radio (e.g., a wireless wide area network (WWAN) radio).

2. Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, single-carrier frequency-division multiple access (SC-FDMA) systems, and orthogonal frequency-division multiple access (OFDMA) systems.

By way of example, a wireless multiple-access communication system may include a number of base stations, each simultaneously supporting communication for multiple communication devices, otherwise known as user equipments (UEs). A base station may communicate with UEs on downlink channels (e.g., for transmissions from a base station to a UE) and uplink channels (e.g., for transmissions from a UE to a base station).

Some modes of communication may enable communication between a base station and a UE over a shared radio frequency spectrum, or over different radio frequency spectrums (e.g., a dedicated radio frequency spectrum and a shared radio frequency spectrum) of a cellular network. With increasing data traffic in cellular networks that use a dedicated (e.g., licensed) radio frequency spectrum, offloading of at least some data traffic to a shared radio frequency spectrum may provide a cellular operator with opportunities for enhanced data transmission capacity. A shared radio frequency spectrum may also provide service in areas where access to a dedicated radio frequency spectrum is unavailable.

### SUMMARY

The described features generally relate to various techniques for wireless communication. Such techniques may increase the likelihood that a UE receives system information transmitted over a shared radio frequency spectrum. More particularly, a first radio of a UE may attempt to reserve resources of a shared radio frequency spectrum, at a time or times when a second radio of the UE expects to receive a transmission of system information over the shared radio frequency spectrum. When the first radio is able to successfully reserve the shared radio frequency spectrum, the second radio may be more likely to receive a transmission of system information (e.g., because of reduced interference from other nodes that might otherwise transmit over the shared radio frequency spectrum). When the first radio is unable to reserve the shared radio frequency spectrum, the second radio may nonetheless attempt to receive the system information, but in some cases may receive the system information in the presence of interference from other nodes. In other cases, the second radio may be unable to receive the system information when the first radio is unable to reserve the shared radio frequency spectrum.

In a first set of illustrative examples, a method for wireless communication is described. In one configuration, the method may include receiving, at a first radio of a UE, timing information relating to transmission of system information over a shared radio frequency spectrum; transmitting, from the first radio, a signal to reserve resources of the shared radio frequency spectrum based at least in part on the timing information; and monitoring, at a second radio of the UE, the resources of the shared radio frequency spectrum for the system information, the monitoring being independent of a successful reservation of the resources of the shared radio frequency spectrum by the first radio.

In some embodiments of the method, the signal to reserve resources of the shared radio frequency spectrum may include a clear to send (CTS)-to-Self signal. In some of these embodiments, the method may include setting a network allocation vector (NAV) of the CTS-to-Self signal to reserve the resources of the shared radio frequency spectrum for a predetermined period of time.

In some embodiments of the method, the method may include receiving a plurality of transmissions of system information at the second radio. In some of these embodiments, the method may include identifying a failure to receive at least a first transmission of system information at the second radio or a threshold level of interference with at least the first transmission of system information or a combination thereof, and transmitting, from the first radio, the signal to reserve resources of the shared radio frequency spectrum for a second transmission of system information based at least in part on the identifying. In some embodiments, the signal to reserve resources of the shared radio frequency spectrum may include a first signal transmitted for a first transmission of system information, and the method may include determining a failure to reserve the resources of the shared radio frequency spectrum, by the first radio, for the first transmission of system information, and transmitting, from the first radio, a second signal to reserve resources of the shared radio frequency spectrum. In this case, the second signal may be transmitted earlier with respect to transmission of the second transmission of system information than the first signal was transmitted with respect to transmission of the first transmission of system information. In some embodiments, the signal to reserve resources of the shared radio frequency spectrum may include a first signal transmitted for a first transmission of system information, and the method may include identifying a failure to receive at least the first transmission of system information at the second radio or a threshold level of interference with at least the first transmission of system information or a combination thereof, and transmitting, from the first radio, a second signal to reserve resources of the shared radio frequency spectrum. In this case, the second signal may have a higher transmit power than the first signal.

In some embodiments of the method, receiving the timing information at the first radio may include receiving the timing information from the second radio. In some embodiments, the timing information may identify at least one time period over which the system information is transmitted, and the method may include selecting a predetermined period of time to extend until an end of a time period over which the system information is transmitted.

In some embodiments of the method, the resources of the shared radio frequency spectrum may include a channel of the shared radio frequency spectrum. In some embodiments, the first radio may include a wireless local area network (WLAN) radio, and the second radio may include a wireless wide area network (WWAN) radio. In some embodiments, the system information may be received from a base station during a clear channel assessment (CCA)-exempt transmission (CET) period of the base station.

In a second set of illustrative examples, an apparatus for wireless communication is described. In one configuration, the apparatus may include a first radio to receive timing information relating to a transmission of system information over a shared radio frequency spectrum, and to transmit a signal to reserve resources of the shared radio frequency spectrum based at least in part on the timing information. The apparatus may also include a second radio to monitor the resources of the shared radio frequency spectrum for the system information independent of a successful reservation of the resources of the shared radio frequency spectrum by the first radio.

In some embodiments of the apparatus, the signal to reserve resources of the shared radio frequency spectrum may include a CTS-to-Self signal. In some of these embodiments, the apparatus may include a channel reservation manager to set a NAV of the CTS-to-Self signal to reserve the resources of the shared radio frequency spectrum for a predetermined period of time.

In some embodiments of the apparatus, the second radio may receive a plurality of transmissions of system information. In some of these embodiments, the apparatus may include a system information manager to identify a failure to receive at least a first transmission of system information at the second radio or a threshold level of interference with at least the first transmission of system information or a combination thereof; and the first radio may transmit the signal to reserve resources of the shared radio frequency spectrum for a second transmission of system information based at least in part on an identification of the failure to receive or the threshold level of interference identified by the system information manager. In some embodiments, the signal to reserve resources of the shared radio frequency spectrum may include a first signal transmitted for a first transmission of system information to the apparatus, and the apparatus may include a channel reservation manager to determine a failure to reserve the resources of the shared radio frequency spectrum, by the first radio, for the first transmission of system information. The apparatus may also include a timing adapter to adapt a transmission timing of a second signal to reserve resources of the shared radio frequency spectrum. In these embodiments, the first radio may transmit the second signal to reserve the resources of the shared radio frequency spectrum, and the second signal may be transmitted earlier with respect to transmission of the second transmission of system information than the first signal was transmitted with respect to transmission of the first transmission of system information.

In some embodiments, the first radio may include a WLAN radio, and the second radio may include a WWAN radio.

In a third set of illustrative examples, another apparatus for wireless communication is described. In one configuration, the apparatus may include means for receiving, at a first radio, timing information relating to a transmission of system information over a shared radio frequency spectrum; means for transmitting, from the first radio, a signal to reserve resources of the shared radio frequency spectrum based at least in part on the timing information; and means for monitoring, at a second radio, the resources of the shared radio frequency spectrum for the system information, the monitoring being independent of a successful reservation of the resources of the shared radio frequency spectrum by the first radio.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communication system, in accordance with various aspects of the disclosure;

FIG. 2 shows a wireless communication system in which LTE/LTE-A may be deployed under different scenarios using a shared radio frequency spectrum, in accordance with various aspects of the present disclosure;

FIG. 3 illustrates an example of a wireless communication system, in accordance with various aspects of the disclosure;

FIG. 4 is a timing diagram illustrating aspects of wireless communication, in accordance with various aspects of the present disclosure;

FIG. 5 is a swim lane diagram illustrating aspects of wireless communication, in accordance with various aspects of the present disclosure;

FIG. 6 is a swim lane diagram illustrating aspects of wireless communication, in accordance with various aspects of the present disclosure;

FIG. 7 is a swim lane diagram illustrating aspects of wireless communication, in accordance with various aspects of the present disclosure;

FIG. 8 shows a block diagram of an apparatus for use in wireless communication, in accordance with various aspects of the present disclosure;

FIG. 9 shows a block diagram of an apparatus for use in wireless communication, in accordance with various aspects of the present disclosure;

FIG. 10 shows a block diagram of a UE for use in wireless communication, in accordance with various aspects of the present disclosure;

FIG. 11 is a flow chart illustrating an example of a method for wireless communication, in accordance with various aspects of the present disclosure;

FIG. 12 is a flow chart illustrating an example of a method for wireless communication, in accordance with various aspects of the present disclosure; and

FIG. 13 is a flow chart illustrating an example of a method for wireless communication, in accordance with various aspects of the present disclosure.

### DETAILED DESCRIPTION

Techniques are described in which a shared radio frequency spectrum is used for at least some communications in a wireless communication system. In some examples, the shared radio frequency spectrum may be used for LTE/LTE-A communications. The shared radio frequency spectrum may be used in combination with, or independent from, a dedicated radio frequency spectrum. The dedicated radio frequency spectrum may be a radio frequency spectrum for which transmitting apparatuses may not contend for access because the radio frequency spectrum is licensed to particular users, such as a licensed radio frequency spectrum usable for LTE/LTE-A communications. The shared radio frequency spectrum may be a radio frequency spectrum for which a device may need to contend for access (e.g., a radio frequency spectrum that is available for unlicensed use, such as Wi-Fi use, or a radio frequency spectrum that is available for use by multiple operators in an equally shared or prioritized manner).

With increasing data traffic in cellular networks that use a dedicated radio frequency spectrum, offloading of at least some data traffic to a shared radio frequency spectrum may provide a cellular operator (e.g., an operator of a public land mobile network (PLMN) or a coordinated set of base stations defining a cellular network, such as an LTE/LTE-A network), with opportunities for enhanced data transmission capacity. Use of a shared radio frequency spectrum may also provide service in areas where access to a dedicated radio frequency spectrum is unavailable. Before communicating over a shared radio frequency spectrum, transmitting apparatuses may typically perform a Listen Before Talk (LBT) procedure to gain access to the medium. Such an LBT procedure may include performing a clear channel assessment (CCA) procedure (or extended CCA procedure) to determine whether a channel of the shared radio frequency spectrum is available. When it is determined that the channel of the shared radio frequency spectrum is available, a channel usage beacon signal (CUBS) may be transmitted to reserve the channel. When it is determined that a channel is not available, a CCA procedure (or extended CCA procedure) may be performed for the channel again at a later time.

Some transmissions over a shared radio frequency spectrum may be deemed important enough that their transmission may be allowed regardless of whether a transmitting apparatus has won contention for access to the shared radio frequency spectrum. Such transmissions may include transmissions of system information, such as a primary synchronization signal (PSS), a secondary synchronization signal (SSS), a physical broadcast channel (PBCH), or a discovery signal. In some cases, a transmitting apparatus such as a base station or UE may be provided a periodic CCA-exempt transmission (CET) period, in which transmissions may be made over the shared radio frequency spectrum, by the transmitting apparatus, without contending for access to the shared radio frequency spectrum. However, because a transmission during a CET period is made without contending for access to the shared radio frequency spectrum, it is possible that other transmitting apparatuses may be using the shared radio frequency spectrum during the CET period. Use of the shared radio frequency spectrum by the other transmitting apparatus(es) may interfere with a receiving apparatus' receipt of a transmission during a CET period. For example, transmissions by Wi-Fi nodes during a CET period may interfere with a base station's transmission of system information to a UE during the CET period. Techniques disclosed in the present disclosure therefore provide ways for a UE to potentially reserve a shared radio frequency spectrum despite not contending for access to the shared radio frequency spectrum.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

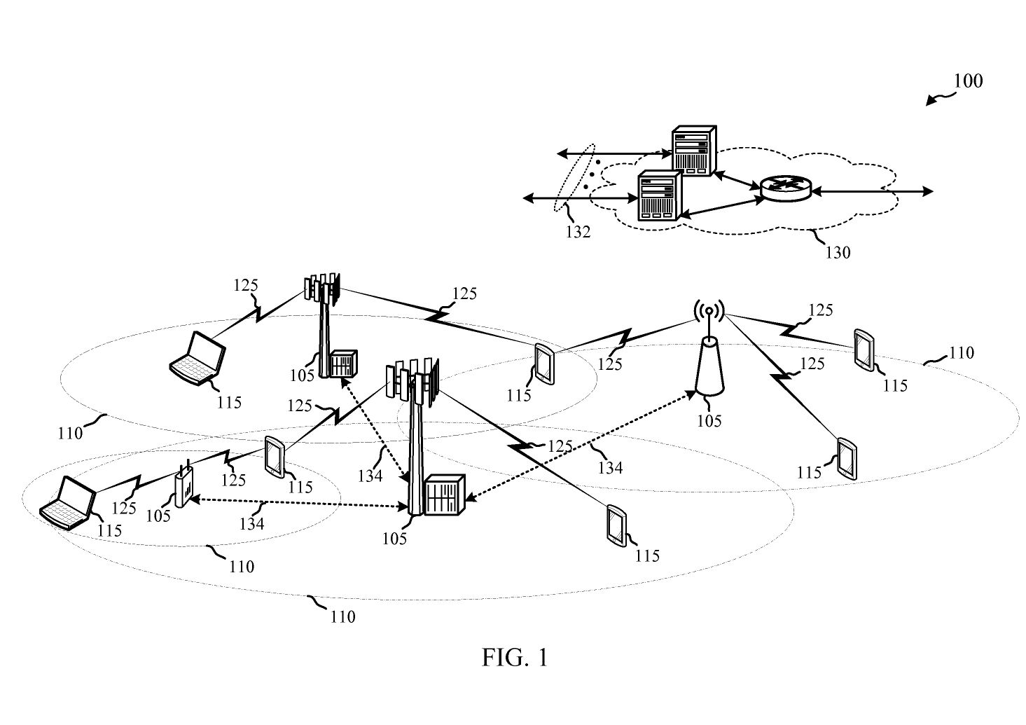

FIG. 1 illustrates an example of a wireless communication system 100, in accordance with various aspects of the disclosure. The wireless communication system 100 may include base stations 105, UEs 115, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., 51, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via at least one base station antenna. Each of the base station 105 sites may provide communication coverage for a respective geographic coverage area 110. In some examples, a base station 105 may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105 may be divided into sectors making up a portion of the coverage area (not shown). The wireless communication system 100 may include base stations 105 of different types (e.g., macro or small cell base stations). There may be overlapping geographic coverage areas 110 for different technologies.

In some examples, the wireless communication system 100 may include an LTE/LTE-A network. In LTE/LTE-A networks, the term evolved Node B (eNB) may be used to describe the base stations 105, while the term UE may be used to describe the UEs 115. The wireless communication system 100 may be a Heterogeneous LTE/LTE-A network in which different types of eNBs provide coverage for various geographical regions. For example, each eNB or base station 105 may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., dedicated, shared, etc.) radio frequency spectrums as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the physical (PHY) layer, the transport channels may be mapped to physical channels.

The UEs 115 may be dispersed throughout the wireless communication system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment, including macro eNBs, small cell eNBs, relay base stations, and the like.

The communication links 125 shown in wireless communication system 100 may include downlink (DL) transmissions, from a base station 105 to a UE 115, or uplink (UL) transmissions, from a UE 115 to a base station 105. The downlink transmissions may also be called forward link transmissions, while the uplink transmissions may also be called reverse link transmissions. The downlink transmissions may include, for example, transmissions of system information (e.g., a PSS, an SSS, a PBCH, or a discovery signal).

In some examples, each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using a frequency domain duplexing (FDD) operation (e.g., using paired spectrum resources) or a time domain duplexing (TDD) operation (e.g., using unpaired spectrum resources). Frame structures for FDD operation (e.g., frame structure type 1) and TDD operation (e.g., frame structure type 2) may be defined.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input, multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or dual-connectivity operation. A carrier may also be referred to as a component carrier (CC), a layer, a channel, etc. The terms “carrier,” “component carrier,” “cell,” and “channel” may be used interchangeably herein. A UE 115 may have multiple downlink CCs and at least one uplink CC for carrier aggregation. Carrier aggregation may be used with both FDD and TDD component carriers.

In some examples, the wireless communication system 100 may support operation over a dedicated radio frequency spectrum or a shared radio frequency spectrum. In some examples, transmissions of system information may be made by a base station 105, to a UE 115, over the shared radio frequency spectrum.

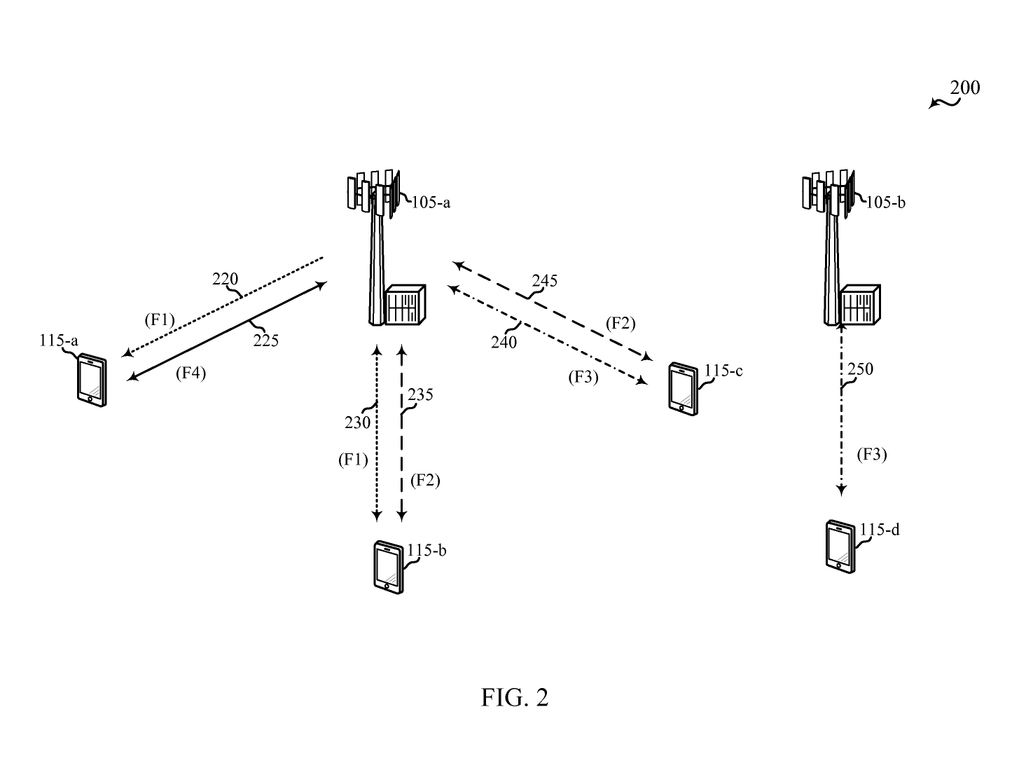

FIG. 2 shows a wireless communication system 200 in which LTE/LTE-A may be deployed under different scenarios using a shared radio frequency spectrum, in accordance with various aspects of the present disclosure. More specifically, FIG. 2 illustrates examples of a supplemental downlink mode (also referred to as a licensed assisted access mode), a carrier aggregation mode, and a standalone mode in which LTE/LTE-A is deployed using a shared radio frequency spectrum. The wireless communication system 200 may be an example of portions of the wireless communication system 100 described with reference to FIG. 1. Moreover, a first base station 105-a and a second base station 105-b may be examples of aspects of at least one of the base stations 105 described with reference to FIG. 1, while a first UE 115-a, a second UE 115-b, a third UE 115-c, and a fourth UE 115-d may be examples of aspects of at least one of the UEs 115 described with reference to FIG. 1.

In the example of a supplemental downlink mode (e.g., a licensed assisted access mode) in the wireless communication system 200, the first base station 105-a may transmit OFDMA waveforms to the first UE 115-a using a downlink channel 220. The downlink channel 220 may be associated with a frequency F1 in a shared radio frequency spectrum. The first base station 105-a may transmit OFDMA waveforms to the first UE 115-a using a first bidirectional link 225 and may receive SC-FDMA waveforms from the first UE 115-a using the first bidirectional link 225. The first bidirectional link 225 may be associated with a frequency F4 in a dedicated radio frequency spectrum. The downlink channel 220 in the shared radio frequency spectrum and the first bidirectional link 225 in the dedicated radio frequency spectrum may operate contemporaneously. The downlink channel 220 may provide a downlink capacity offload for the first base station 105-a. In some examples, the downlink channel 220 may be used for unicast services (e.g., addressed to one UE) or for multicast services (e.g., addressed to several UEs). This scenario may occur with any service provider (e.g., a mobile network operator (MNO)) that uses a dedicated radio frequency spectrum and needs to relieve some of the traffic or signaling congestion.

In one example of a carrier aggregation mode in the wireless communication system 200, the first base station 105-a may transmit OFDMA waveforms to the second UE 115-b using a second bidirectional link 230 and may receive OFDMA waveforms, SC-FDMA waveforms, or resource block interleaved FDMA waveforms from the second UE 115-b using the second bidirectional link 230. The second bidirectional link 230 may be associated with the frequency F1 in the shared radio frequency spectrum. The first base station 105-a may also transmit OFDMA waveforms to the second UE 115-b using a third bidirectional link 235 and may receive SC-FDMA waveforms from the second UE 115-b using the third bidirectional link 235. The third bidirectional link 235 may be associated with a frequency F2 in a dedicated radio frequency spectrum. The second bidirectional link 230 may provide a downlink and uplink capacity offload for the first base station 105-a. Like the supplemental downlink (e.g., the licensed assisted access mode) described above, this scenario may occur with any service provider (e.g., MNO) that uses a dedicated radio frequency spectrum and needs to relieve some of the traffic or signaling congestion.

In another example of a carrier aggregation mode in the wireless communication system 200, the first base station 105-a may transmit OFDMA waveforms to the third UE 115-c using a fourth bidirectional link 240 and may receive OFDMA waveforms, SC-FDMA waveforms, or resource block interleaved waveforms from the third UE 115-c using the fourth bidirectional link 240. The fourth bidirectional link 240 may be associated with a frequency F3 in the shared radio frequency spectrum. The first base station 105-a may also transmit OFDMA waveforms to the third UE 115-c using a fifth bidirectional link 245 and may receive SC-FDMA waveforms from the third UE 115-c using the fifth bidirectional link 245. The fifth bidirectional link 245 may be associated with the frequency F2 in the dedicated radio frequency spectrum. The fourth bidirectional link 240 may provide a downlink and uplink capacity offload for the first base station 105-a. This example and those provided above are presented for illustrative purposes and there may be other similar modes of operation or deployment scenarios that combine LTE/LTE-A in a dedicated radio frequency spectrum and use a shared radio frequency spectrum for capacity offload.

As described above, one type of service provider that may benefit from the capacity offload offered by using LTE/LTE-A in a shared radio frequency spectrum is a traditional MNO having access rights to an LTE/LTE-A dedicated radio frequency spectrum. For these service providers, an operational example may include a bootstrapped mode (e.g., supplemental downlink (e.g., licensed assisted access), carrier aggregation) that uses the LTE/LTE-A primary component carrier (PCC) on the dedicated radio frequency spectrum and at least one secondary component carrier (SCC) on the shared radio frequency spectrum.

In the carrier aggregation mode, data and control may, for example, be communicated in the dedicated radio frequency spectrum (e.g., via first bidirectional link 225, third bidirectional link 235, and fifth bidirectional link 245) while data may, for example, be communicated in the shared radio frequency spectrum (e.g., via second bidirectional link 230 and fourth bidirectional link 240). The carrier aggregation mechanisms supported when using a shared radio frequency spectrum may fall under a hybrid frequency division duplexing-time division duplexing (FDD-TDD) carrier aggregation or a TDD-TDD carrier aggregation with different symmetry across component carriers.

In one example of a standalone mode in the wireless communication system 200, the second base station 105-b may transmit OFDMA waveforms to the fourth UE 115-d using a bidirectional link 250 and may receive OFDMA waveforms, SC-FDMA waveforms, or resource block interleaved FDMA waveforms from the fourth UE 115-d using the bidirectional link 250. The bidirectional link 250 may be associated with the frequency F3 in the shared radio frequency spectrum. The standalone mode may be used in non-traditional wireless access scenarios, such as in-stadium access (e.g., unicast, multicast). An example of a type of service provider for this mode of operation may be a stadium owner, cable company, event host, hotel, enterprise, or large corporation that does not have access to a dedicated radio frequency spectrum.

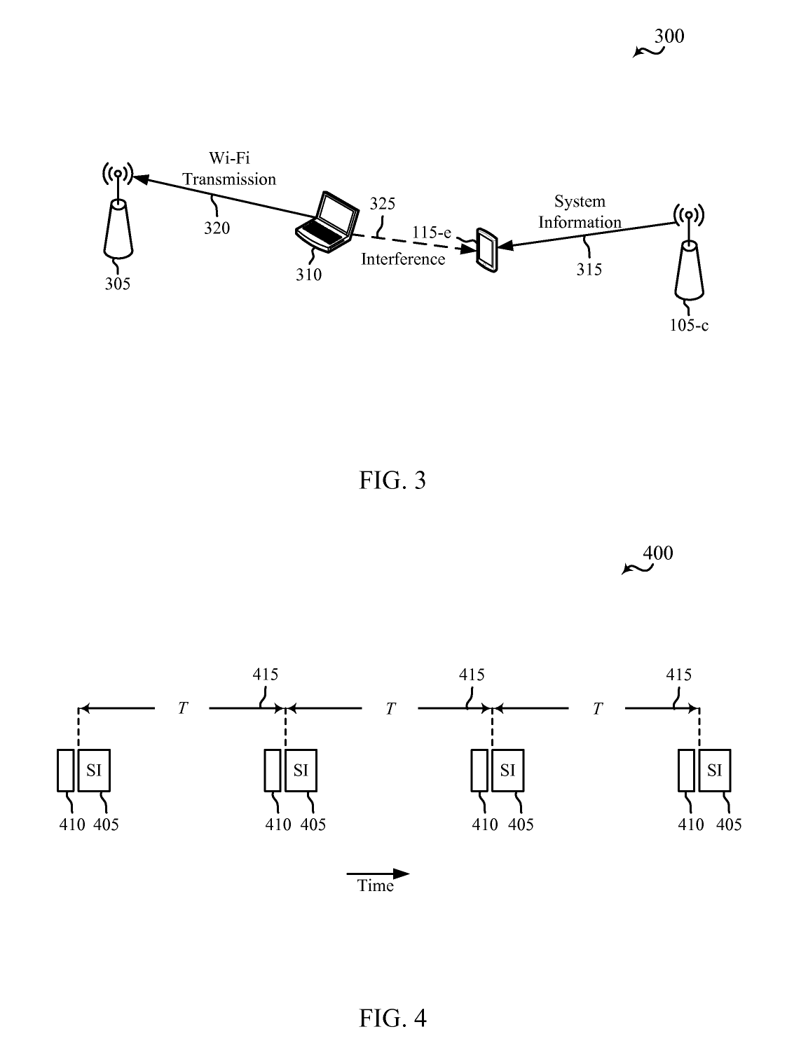

FIG. 3 illustrates an example of a wireless communication system 300, in accordance with various aspects of the disclosure. The wireless communication system 300 may include a base station 105-c, a UE 115-e, a Wi-Fi access point 305, and a Wi-Fi station 310. Each of the Wi-Fi access point 305 and the Wi-Fi station 310 may be referred to more generically as a Wi-Fi node.

As shown in FIG. 3, the base station 105-c may transmit system information 315 to the UE 115-e over a shared radio frequency spectrum. In some cases, the system information 315 may be transmitted during a CET period, and thus, the base station 105-c may not have won contention for access to the shared radio frequency spectrum, and the Wi-Fi station 310 may make a Wi-Fi transmission 320 to the Wi-Fi access point 305 while the base station 105-c is transmitting the system information 315 to the UE 115-e. Alternatively, the base station 105-c may have won contention for access to the shared radio frequency spectrum, but the Wi-Fi station 310 may be outside the coverage area of the base station 105-c. Thus, the Wi-Fi station 310 may not receive a channel reservation signal (e.g., a CUBS) transmitted by the base station 105-c and may be unaware of the base station's reservation or use of the shared radio frequency spectrum. In either case, the Wi-Fi transmission 320 may be received at the UE 115-e as an interference signal 325, which interference signal 325 may interfere with the UE's receipt of the system information 315.

To reduce the likelihood that the Wi-Fi station 310 (or Wi-Fi access point 305) makes a transmission that interferes with the UE's receipt of the system information 315, the UE 115-e may transmit a signal to reserve resources of the shared radio frequency spectrum for transmission/receipt of the system information 315. The signal may be transmitted just before the system information 315 is expected to be transmitted, as indicated by timing information received at the UE 115-e from the base station 105-c. In some cases, the signal may be transmitted by a first radio (e.g., a WLAN radio) of the UE 115-e, and the system information 315 may be received at a second radio (e.g., a WWAN radio) of the UE 115-e. The timing information on which the signal to reserve the resources of the shared radio frequency spectrum is based may initially be received at the second radio of the UE 115-e. Part or all of the timing information may then be passed to the first radio of the UE 115-e, possibly after being converted to a format understandable by the first radio.

FIG. 4 is a timing diagram 400 illustrating aspects of wireless communication, in accordance with various aspects of the present disclosure. In particular, the timing diagram 400 shows transmissions over a shared radio frequency spectrum during a plurality of CET periods 415 of a base station. In some examples, the CET periods may occur with a periodicity T. In some examples, T may have a duration of 80 milliseconds (ms) or eight radio frames. The transmissions include transmissions of system information (SI) 405 once every CET period. The system information 405 may be transmitted by a base station such as one of the base stations 105 described with reference to FIGS. 1-3. The transmissions shown in FIG. 4 may also include transmissions of signals 410 to reserve the shared radio frequency spectrum. The signals 410 to reserve the shared radio frequency spectrum may be transmitted by a UE such as one of the UEs 115 described with reference to FIGS. 1-3. The signals 410 may be transmitted by the UE just before respective transmissions of the system information 405 by the base station. In some examples, the signals 410 may include Clear-to-Send (CTS)-to-Self signals. Each CTS-to-Self signal may include a network allocation vector (NAV) that reserves the shared radio frequency spectrum for a predetermined period of time including a transmission of system information 405.

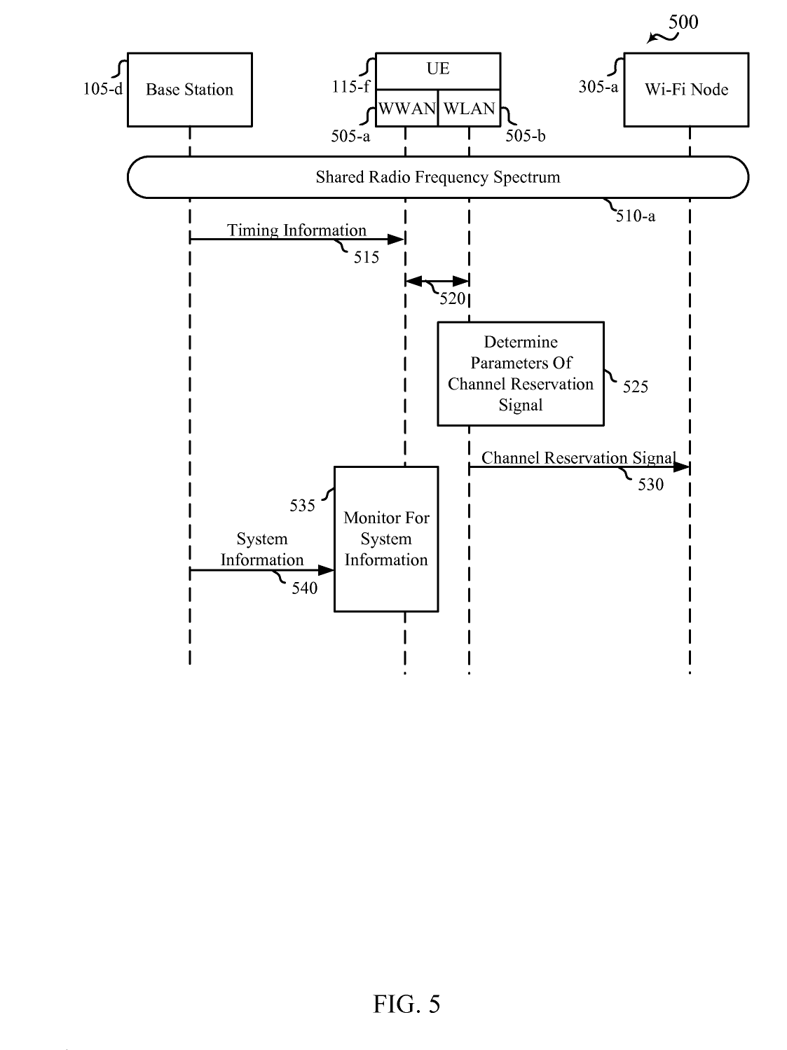

FIG. 5 is a swim lane diagram 500 illustrating aspects of wireless communication, in accordance with various aspects of the present disclosure. The diagram 500 may illustrate aspects of the wireless communication systems 100, 200, or 300 described with reference to FIG. 1, 2, or 3. The diagram 500 includes a UE 115-f, a base station 105-d, and a Wi-Fi node 305-a. The UE 115-f may be an example of aspects of the UEs 115 described with reference to FIGS. 1-3. The base station 105-d may be an example of aspects of the base stations 105 described with reference to FIGS. 1-3. The Wi-Fi node 305-a may be an example of aspects of the Wi-Fi access point 305 or Wi-Fi station 310 described with reference to FIG. 3. Generally, the diagram 500 illustrates aspects of using a first radio (e.g., a WLAN radio 505-b) of the UE 115-f to clear a shared radio frequency spectrum 510-a for receipt of system information at a second radio (e.g., a WWAN radio 505-a) of the UE 115-f. In some examples, each of the WLAN radio 505-b and the WWAN radio 505-a may include or be associated with a modem or processor. In some examples, a system device, such as the UE 115-f, base station 105-d, or Wi-Fi node 305-a may execute instructions or code to control the functional elements of the device to perform some or all of the functions described below.

At 515, the base station 105-d may transmit timing information to the UE 115-f. The timing information may relate to a transmission of system information over the shared radio frequency spectrum 510-a. In some examples, the timing information may identify at least one time period over which the system information is transmitted. Although the timing information is shown to be transmitted over the shared radio frequency spectrum 510-a, the timing information may alternatively be transmitted over a dedicated radio frequency spectrum. The timing information may be received at the WWAN radio 505-a of the UE 115-f. At 520, the WWAN radio 505-a of the UE 115-f may pass part or all of the timing information to the WLAN radio 505-b of the UE 115-f. In some examples, the UE 115-f may process the timing information received at 515 and convert part or all of the timing information to a form understandable by the WLAN radio 505-b.

At block 525, the UE 115-f may determine parameters of a channel reservation signal. The channel reservation signal may be transmitted from the WLAN radio 505-b at 530 to reserve resources of the shared radio frequency spectrum 510-a. The channel reservation signal may be transmitted based at least in part on the timing information. In some examples, the channel reservation signal may include a CTS-to-Self signal. When the channel reservation signal includes a CTS-to-self signal, the CTS-to-self signal may have a NAV set to reserve the resources of the shared radio frequency spectrum 510-a for a predetermined period of time, which predetermined period of time may be selected to extend until an end of a time period over which the system information is transmitted by the base station 105-d. In some examples, the resources may include a channel of the shared radio frequency spectrum 510-a.

The channel reservation signal transmitted at 530 may be received by the Wi-Fi node 305-a or other Wi-Fi nodes and may cause the Wi-Fi node 305-a or other Wi-Fi nodes to refrain from using the shared radio frequency spectrum 510-a for the predetermined period of time specified by the channel reservation signal. Because the channel reservation signal is transmitted from the WLAN radio 505-b and may be formatted using a protocol or protocols understood by the Wi-Fi node 305-a, the channel reservation signal may be more likely to succeed in reserving the shared radio frequency spectrum 510-a than a channel reservation signal transmitted from the WWAN radio 505-a. In some cases, a channel reservation signal transmitted from the WWAN radio 505-a may be less detectable by the Wi-Fi node 305-a (e.g., in some cases, a channel reservation signal transmitted from the WWAN radio 505-a may be detected by the Wi-Fi node 305-a as energy on the shared radio frequency spectrum 510-a, and may be detected with less sensitivity, whereas a channel reservation signal transmitted from the WLAN radio 505-b may be detected and decoded by the Wi-Fi node 305-a, and may be detected with greater sensitivity).

At block 535, the WWAN radio 505-a of the UE 115-f may monitor resources of the shared radio frequency spectrum 510-a (e.g., the resources that the WLAN radio 505-b attempted to reserve at 530) for the system information transmitted by the base station 105-d. The monitoring may be undertaken in accordance with the timing information received at 515. The monitoring need not be dependent on a successful reservation of the resources by the WLAN radio 505-b. Instead, the monitoring may be performed independent of a successful reservation of the resources by the WLAN radio 505-b. Thus, the WLAN radio 505-b may attempt to reserve the resources at 530, to improve the chance that system information transmitted by the base station 105-d will be received at 540. However, when the attempt of the WLAN radio 505-b to reserve the resources is unsuccessful (e.g., because the Wi-Fi node 305-a or another node has already reserved the resources), the WWAN radio 505-a may still monitor the resources of the shared radio frequency spectrum 510-a for the system information transmitted by the base station 105-d, but may receive the system information in the presence of interference. If the interference is too great, the interference may prevent the WWAN radio 505-a from receiving part or all of the system information at 540.

In some examples, the base station 105-d may transmit system information on a plurality of occasions or in a periodic manner. For example, the base station 105-d may transmit system information during each of a plurality of CET periods of the base station 105-d, as described, for example, with reference to FIG. 4. In these examples, the operations performed by the UE 115-f, base station 105-d, and Wi-Fi node 305-a at 525, 530, 535, and 540 may be repeated. The operations performed by the UE 115-f and base station 105-d at 515 and 520 may also be repeated (e.g., with each iteration of the operations at 525, 530, 535, and 540, or with a lower periodicity).

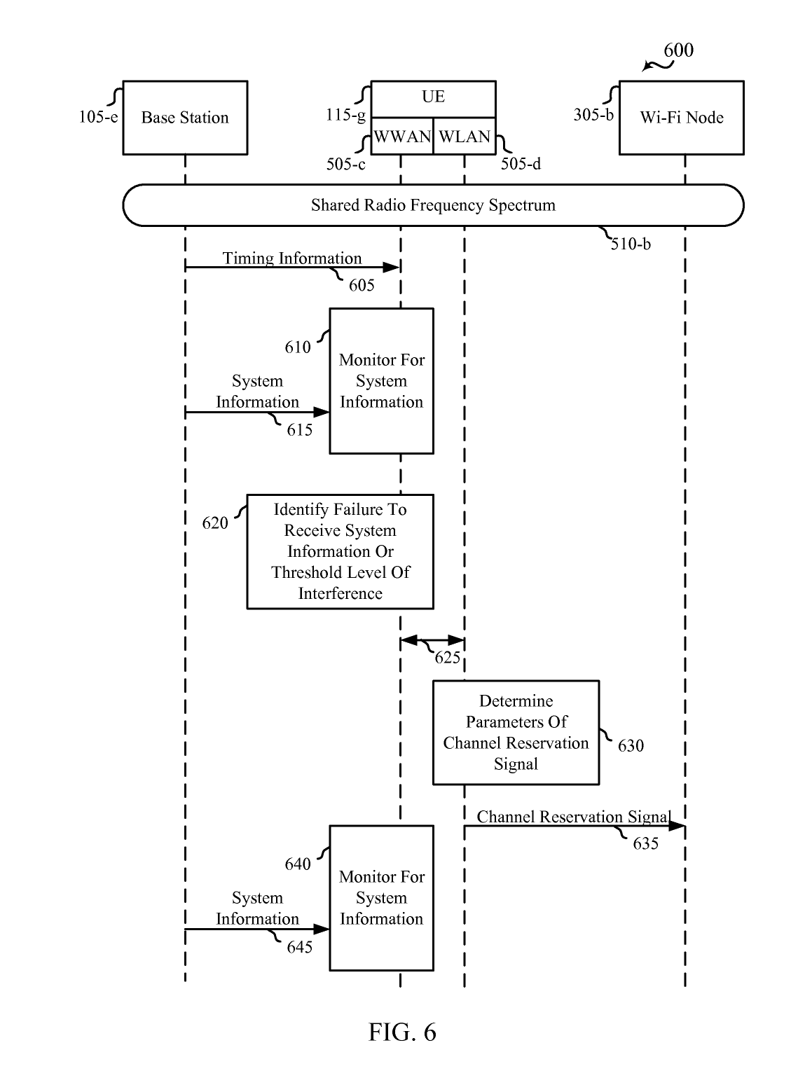

FIG. 6 is a swim lane diagram 600 illustrating aspects of wireless communication, in accordance with various aspects of the present disclosure. The diagram 600 may illustrate aspects of the wireless communication systems 100, 200, or 300 described with reference to FIG. 1, 2, or 3. The diagram 600 includes a UE 115-g, a base station 105-e, and a Wi-Fi node 305-b. The UE 115-g may be an example of aspects of the UEs 115 described with reference to FIGS. 1-3 and 5. The base station 105-e may be an example of aspects of the base stations 105 described with reference to FIGS. 1-3 and 5. The Wi-Fi node 305-b may be an example of aspects of the Wi-Fi access point 305 or Wi-Fi station 310 described with reference to FIG. 3.

Generally, the diagram 600 illustrates aspects of using a first radio (e.g., a WLAN radio 505-d) of the UE 115-g to clear a shared radio frequency spectrum 510-b for receipt of system information at a second radio (e.g., a WWAN radio 505-c) of the UE 115-g. In some examples, each of the WLAN radio 505-d and the WWAN radio 505-c may include or be associated with a modem or processor. In some examples, a system device, such as the UE 115-g, base station 105-e, or Wi-Fi node 305-b may execute instructions or code to control the functional elements of the device to perform some or all of the functions described below.

At 605, the base station 105-e may transmit timing information to the UE 115-g. The timing information may relate to a transmission of system information over the shared radio frequency spectrum 510-b. In some examples, the timing information may identify at least one time period over which the system information is transmitted. Although the timing information is shown to be transmitted over the shared radio frequency spectrum 510-b, the timing information may alternatively be transmitted over a dedicated radio frequency spectrum. The timing information may be received at the WWAN radio 505-c of the UE 115-g.

At block 610, the WWAN radio 505-c of the UE 115-g may monitor resources of the shared radio frequency spectrum 510-b for a first transmission of system information transmitted by the base station 105-e. The monitoring may be undertaken in accordance with the timing information received at 605. At 615, the base station may transmit the first transmission of system information, to the UE 115-g, in accordance with the timing information. The system information may or may not be received at the WWAN radio 505-c of the UE 115-g.

At block 620, the UE 115-g (or the WWAN radio 505-c of the UE 115-g) may identify at least one of a failure to receive at least the first transmission of system information at the WWAN radio, a threshold level of interference with at least the first transmission of system information, or a combination thereof. Upon identifying one of these events, and at 625, the WWAN radio 505-c may pass part or all of the timing information to the WLAN radio 505-d. In some examples, the UE 115-g may process the timing information received at 605 and convert part or all of the timing information to a form understandable by the WLAN radio 505-d.

At block 630, the UE 115-g may determine parameters of a channel reservation signal. The channel reservation signal may be transmitted from the WLAN radio 505-d at 635 to reserve resources of the shared radio frequency spectrum 510-b for a second transmission of system information by the base station 105-e. The channel reservation signal may be transmitted based at least in part on the timing information. In some examples, the channel reservation signal may include a CTS-to-Self signal. When the channel reservation signal includes a CTS-to-self signal, the CTS-to-self signal may have a NAV set to reserve the resources of the shared radio frequency spectrum 510-b for a predetermined period of time, which predetermined period of time may be selected to extend until an end of a time period over which the second transmission of system information is made by the base station 105-e. In some examples, the resources may include a channel of the shared radio frequency spectrum 510-b.

The channel reservation signal transmitted at 635 may be received by the Wi-Fi node 305-b or other Wi-Fi nodes and may cause the Wi-Fi node 305-b or other Wi-Fi nodes to refrain from using the shared radio frequency spectrum 510-b for the predetermined period of time specified by the channel reservation signal. Because the channel reservation signal is transmitted from the WLAN radio 505-d and may be formatted using a protocol or protocols understood by the Wi-Fi node 305-b, the channel reservation signal may be more likely to succeed in reserving the shared radio frequency spectrum 510-b than a channel reservation signal transmitted from the WWAN radio 505-c. In some cases, a channel reservation signal transmitted from the WWAN radio 505-c may be less detectable by the Wi-Fi node 305-b (e.g., in some cases, a channel reservation signal transmitted from the WWAN radio 505-c may be detected by the Wi-Fi node 305-b as energy on the shared radio frequency spectrum 510-b, and may be detected with less sensitivity, whereas a channel reservation signal transmitted from the WLAN radio 505-d may be detected and decoded by the Wi-Fi node 305-b, and may be detected with greater sensitivity).

At block 640, the WWAN radio 505-c of the UE 115-g may monitor resources of the shared radio frequency spectrum 510-b (e.g., the resources that the WLAN radio 505-d attempted to reserve at 635) for the system information transmitted by the base station 105-e. The monitoring may be undertaken in accordance with the timing information received at 605. The monitoring need not be dependent on a successful reservation of the resources by the WLAN radio 505-d. Instead, the monitoring may be performed independent of a successful reservation of the resources by the WLAN radio 505-d. Thus, the WLAN radio 505-d may attempt to reserve the resources at 635, to improve the chance that system information transmitted by the base station 105-e will be received at 645. However, when the attempt of the WLAN radio 505-d to reserve the resources is unsuccessful (e.g., because the Wi-Fi node 305-b or another node has already reserved the resources), the WWAN radio 505-c may still monitor the resources of the shared radio frequency spectrum 510-b for the system information transmitted by the base station 105-e, but may receive the system information in the presence of interference. If the interference is too great, the interference may prevent the WWAN radio 505-c from receiving part or all of the system information at 545.

In some examples, the base station 105-e may transmit system information on a plurality of occasions including the occasions at 615 and 645, and in some cases may transmit system information in a periodic manner. For example, the base station 105-e may transmit system information during each of a plurality of CET periods of the base station 105-e, as described, for example, with reference to FIG. 4.

In contrast to the operations performed in accord with the swim lane diagram 500, the operations performed in accord with the swim lane diagram 600 may enable the UE 115-g to save power by waiting to employ the WLAN radio 505-d to aid the reception of system information at the WWAN radio 505-c. That is, the UE 115-g may wait to employ the WLAN radio 505-d until a failure to receive system information or a threshold level of interference is identified.

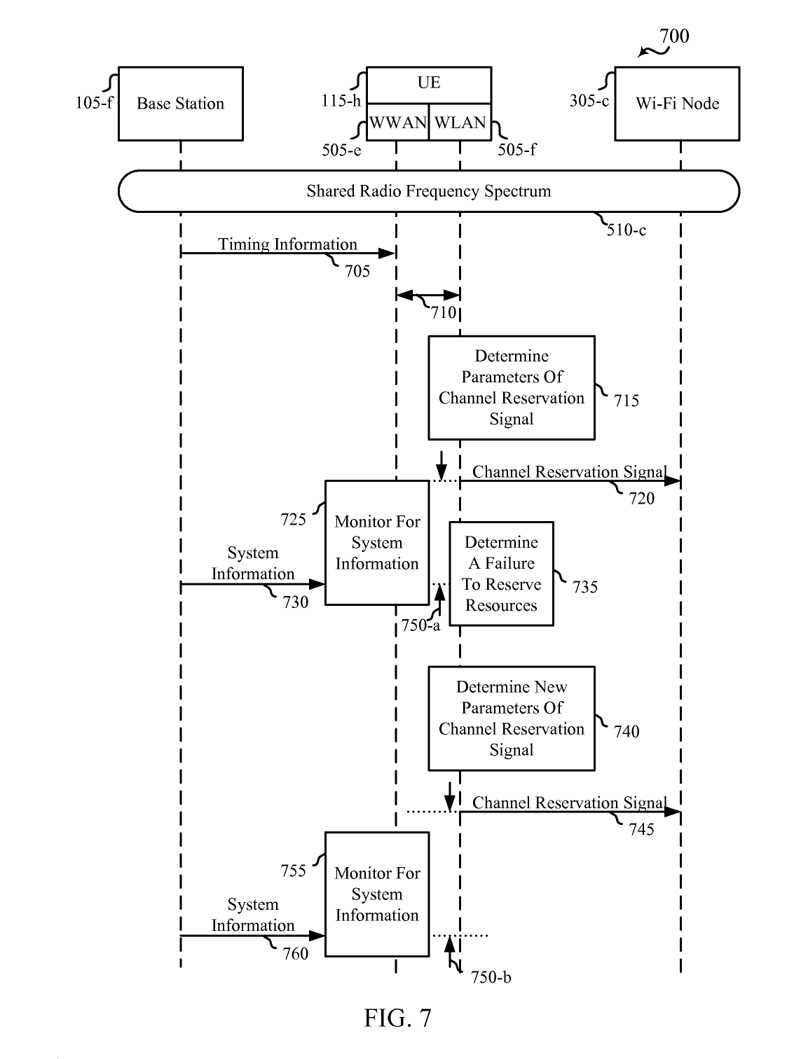

FIG. 7 is a swim lane diagram 700 illustrating aspects of wireless communication, in accordance with various aspects of the present disclosure. The diagram 700 may illustrate aspects of the wireless communication systems 100, 200, or 300 described with reference to FIG. 1, 2, or 3. The diagram 700 includes a UE 115-h, a base station 105-f, and a Wi-Fi node 305-c. The UE 115-h may be an example of aspects of the UEs 115 described with reference to FIGS. 1-3, 5, and 6. The base station 105-f may be an example of aspects of the base stations 105 described with reference to FIGS. 1-3, 5, and 6. The Wi-Fi node 305-c may be an example of aspects of the Wi-Fi access point 305 or Wi-Fi station 310 described with reference to FIG. 3.

Generally, the diagram 700 illustrates aspects of using a first radio (e.g., a WLAN radio 505-f) of the UE 115-h to clear a shared radio frequency spectrum 510-c for receipt of system information at a second radio (e.g., a WWAN radio 505-e) of the UE 115-h. In some examples, each of the WLAN radio 505-f and the WWAN radio 505-e may include or be associated with a modem or processor. In some examples, a system device, such as the UE 115-h, base station 105-f, or Wi-Fi node 305-c may execute instructions or code to control the functional elements of the device to perform some or all of the functions described below.

At 705, the base station 105-f may transmit timing information to the UE 115-h. The timing information may relate to a transmission of system information over the shared radio frequency spectrum 510-c. In some examples, the timing information may identify at least one time period over which the system information is transmitted. Although the timing information is shown to be transmitted over the shared radio frequency spectrum 510-c, the timing information may alternatively be transmitted over a dedicated radio frequency spectrum. The timing information may be received at the WWAN radio 505-e of the UE 115-h. At 710, the WWAN radio 505-e of the UE 115-h may pass part or all of the timing information to the WLAN radio 505-f of the UE 115-h. In some examples, the UE 115-h may process the timing information received at 705 and convert part or all of the timing information to a form understandable by the WLAN radio 505-f.

At block 715, the UE 115-h may determine parameters of a first channel reservation signal. The first channel reservation signal may be transmitted from the WLAN radio 505-f at 720 to reserve resources of the shared radio frequency spectrum 510-c for a first transmission of system information by the base station 105-f. The first channel reservation signal may be transmitted based at least in part on the timing information. In some examples, the first channel reservation signal may include a CTS-to-Self signal. When the first channel reservation signal includes a CTS-to-self signal, the CTS-to-self signal may have a NAV set to reserve the resources of the shared radio frequency spectrum 510-c for a predetermined period of time, which predetermined period of time may be selected to extend until an end of a time period over which the first transmission of system information is transmitted by the base station 105-f. In some examples, the resources may include a channel of the shared radio frequency spectrum 510-c.

The first channel reservation signal transmitted at 720 may be received by the Wi-Fi node 305-c or other Wi-Fi nodes and may cause the Wi-Fi node 305-d or other Wi-Fi nodes to refrain from using the shared radio frequency spectrum 510-c for the predetermined period of time specified by the first channel reservation signal. Because the first channel reservation signal is transmitted from the WLAN radio 505-f and may be formatted using a protocol or protocols understood by the Wi-Fi node 305-c, the first channel reservation signal may be more likely to succeed in reserving the shared radio frequency spectrum 510-c than a channel reservation signal transmitted from the WWAN radio 505-e. In some cases, a channel reservation signal transmitted from the WWAN radio 505-e may be less detectable by the Wi-Fi node 305-c (e.g., in some cases, a channel reservation signal transmitted from the WWAN radio 505-e may be detected by the Wi-Fi node 305-c as energy on the shared radio frequency spectrum 510-c, and may be detected with less sensitivity, whereas a channel reservation signal transmitted from the WLAN radio 505-f may be detected and decoded by the Wi-Fi node 305-c, and may be detected with greater sensitivity).

At block 725, the WWAN radio 505-e of the UE 115-h may monitor resources of the shared radio frequency spectrum 510-c (e.g., the resources that the WLAN radio 505-f attempted to reserve at 720) for the first transmission of system information by the base station 105-f. The monitoring may be undertaken in accordance with the timing information received at 705. The monitoring need not be dependent on a successful reservation of the resources by the WLAN radio 505-f. Instead, the monitoring may be performed independent of a successful reservation of the resources by the WLAN radio 505-f. Thus, the WLAN radio 505-f may attempt to reserve the resources at 720, to improve the chance that the first transmission of system information by the base station 105-f will be received at 730. However, when the attempt of the WLAN radio 505-f to reserve the resources is unsuccessful (e.g., because the Wi-Fi node 305-c or another node has already reserved the resources), the WWAN radio 505-e may still monitor the resources of the shared radio frequency spectrum 510-c for the first transmission of system information by the base station 105-f, but may receive the first transmission of system information in the presence of interference. If the interference is too great, the interference may prevent the WWAN radio 505-e from receiving part or all of the first transmission of system information at 730.

At block 735, the UE 115-h may determine a failure to reserve the resources of the shared radio frequency spectrum 510-c, by the WLAN radio 505-f, for the first transmission of system information. As a result, and at block 740, the UE 115-h may determine parameters of a second channel reservation signal. The parameters of the second channel reservation signal may be selected to improve the likelihood that the WLAN radio 505-f will succeed in reserving the shared radio frequency spectrum 510-c for a second transmission of system information by the base station 105-f. For example, the transmission time of the second channel reservation signal may be earlier with respect to transmission of the second transmission of system information (at 760) than the first channel reservation signal was transmitted with respect to transmission of the first transmission of system information (at 730) (e.g., the time interval 750-b may be greater than the time interval 750-a).

The second channel reservation signal may be transmitted from the WLAN radio 505-f at 745 to reserve resources of the shared radio frequency spectrum 510-c for the second transmission of system information by the base station 105-f. The second channel reservation signal may be transmitted based at least in part on the timing information. In some examples, the second channel reservation signal may include a CTS-to-Self signal. When the second channel reservation signal includes a CTS-to-self signal, the CTS-to-self signal may have a NAV set to reserve the resources of the shared radio frequency spectrum 510-c for a predetermined period of time, which predetermined period of time may be selected to extend until an end of a time period over which the second transmission of system information is transmitted by the base station 105-f. In some examples, the resources may include a channel of the shared radio frequency spectrum 510-c.

At block 755, the WWAN radio 505-e of the UE 115-h may monitor resources of the shared radio frequency spectrum 510-c (e.g., the resources that the WLAN radio 505-f attempted to reserve at 745) for the second transmission of system information by the base station 105-f. The monitoring may be undertaken in accordance with the timing information received at 705. The monitoring need not be dependent on a successful reservation of the resources by the WLAN radio 505-f. Instead, the monitoring may be performed independent of a successful reservation of the resources by the WLAN radio 505-f. If interference is not too great, the UE 115-h may receive the second transmission of system information at 760.

In some examples, the base station 105-f may transmit system information on a plurality of occasions including the occasions at 730 and 760, and in some cases may transmit system information in a periodic manner. For example, the base station 105-f may transmit system information during each of a plurality of CET periods of the base station 105-f, as described, for example, with reference to FIG. 4.

The operations performed in accord with the swim lane diagram 700 enable the UE 115-h to improve its chances of reserving resources of the shared radio frequency spectrum 510-c when the WLAN radio 505-f fails to reserve resources of the shared radio frequency spectrum 510-c during a prior reservation attempt. In a variation of the operations disclosed in FIG. 7, the UE 115-h may identify at least one of a failure to receive at least the first transmission of system information at 730, a threshold level of interference with at least the first transmission, or a combination thereof. Upon identifying such an event, the UE 115-h may trigger the operations performed at block 740 or cause the WLAN radio 505-f to increase a transmit power of the channel reservation signal transmitted at 745.

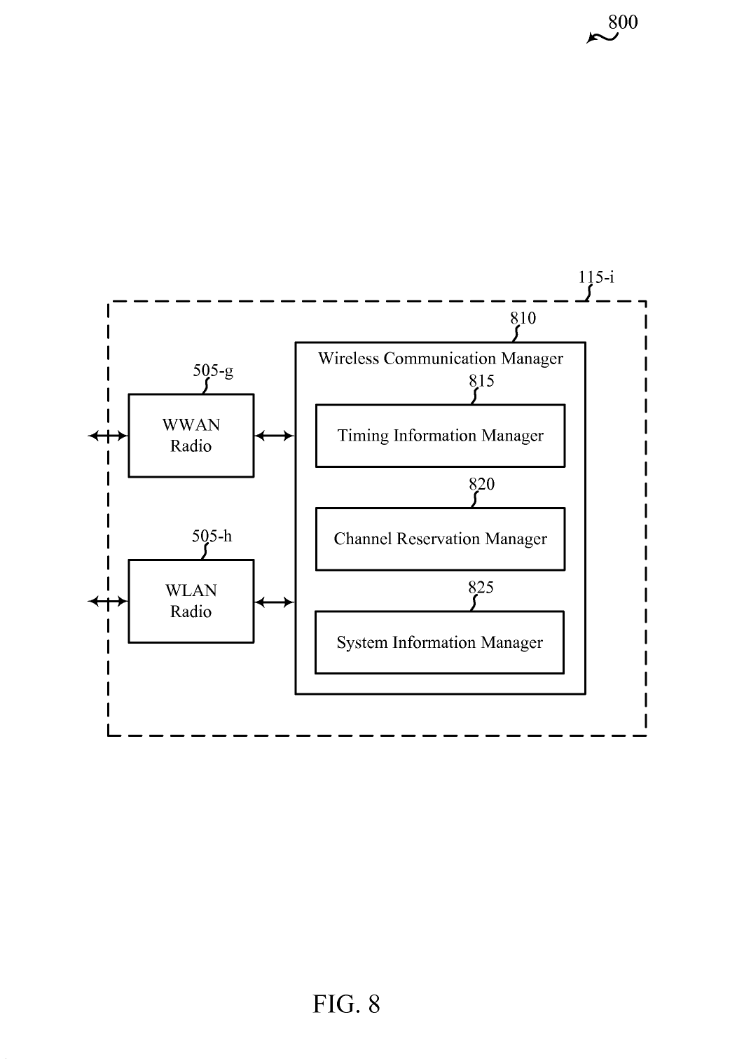

FIG. 8 shows a block diagram 800 of an apparatus 115-i for use in wireless communication, in accordance with various aspects of the present disclosure. In some examples, the apparatus 115-i may be an example of aspects of the UEs 115 described with reference to FIGS. 1-3 and 5-7. The apparatus 115-i may also be or include a processor (not shown). The apparatus 115-i may include a WWAN radio 505-g, a WLAN radio 505-h, and/or a wireless communication manager 810. Each of these components may be in communication with each other.

The apparatus 115-i, through the WWAN radio 505-g, the WLAN radio 505-h, and/or the wireless communication manager 810, may perform functions described herein. For example, the apparatus 115-i may communicate with a base station (e.g., one of the base stations 105 described with reference to FIGS. 1-3 and 5-7) over a shared radio frequency spectrum, and in some cases may receive system information from the base station.

The components of the apparatus 115-i may, individually or collectively, be implemented using application-specific integrated circuits (ASICs) adapted to perform some or all of the applicable functions in hardware. Alternatively, the functions may be performed by other processing units (or cores), on integrated circuits. In other examples, other types of integrated circuits may be used (e.g., Structured/Platform ASICs, Field Programmable Gate Arrays (FPGAs), and other Semi-Custom ICs), which may be programmed in any manner known in the art. The functions of each component may also be implemented, in whole or in part, with instructions embodied in a memory, which instructions may be formatted to be executed by general or application-specific processors.

The WWAN radio 505-g may transmit and receive information such as user data or control information associated with various information channels (e.g., data channels, control channels, etc.). Some of the control information may be system information. The WWAN radio 505-g may transmit and receive information in the form of signals, messages, packets, and the like. The information may be transmitted to and received from at least one base station 105. The information may be transmitted and received over a dedicated radio frequency spectrum and/or a shared radio frequency spectrum, as described, for example, with reference to FIGS. 1-7. In some embodiments, the WWAN radio 505-g may include an LTE/LTE-A radio.

The WLAN radio 505-h may also transmit and receive information such as user data or control information. The WLAN radio 505-h may transmit and receive information in the form of signals, messages, packets, and the like. The information may be transmitted to and received from at least one Wi-Fi access point (e.g., at least one of the Wi-Fi access points 305 described with reference to FIG. 3). The information may be transmitted and received over the shared radio frequency spectrum, as described, for example, with reference to FIG. 3-7.

In some examples, the wireless communication manager 810 may be used to manage at least one aspect of wireless communication for the apparatus 115-i. In some examples, the wireless communication manager 810 may include a timing information manager 815, a channel reservation manager 820, or a system information manager 825.

The timing information manager 815 may be used to manage the receipt of timing information at the WWAN radio 505-g or WLAN radio 505-h. The timing information may relate to a transmission of system information over the shared radio frequency spectrum. In some examples, the timing information may identify at least one time period over which the system information is transmitted (e.g., by a base station). The timing information may be received over the shared radio frequency spectrum or the dedicated radio frequency spectrum. In some examples, the timing information may be received from a base station at the WWAN radio 505-g. Part or all of the timing information may then be passed to the WLAN radio 505-h, as determined by the timing information manager 815. In some examples, the timing information manager 815 may process the timing information and convert part or all of the timing information to a form understandable by the WLAN radio 505-h.

The channel reservation manager 820 may be used to manage transmission of a signal to reserve resources of the shared radio frequency spectrum. The signal may be based at least in part on the received timing information and may be transmitted from the WLAN radio 505-h. The transmitted signal may include, for example, a CTS-to-Self signal (e.g., a CTS-to-self signal having a NAV set to reserve the resources of the shared radio frequency spectrum for a predetermined period of time, which predetermined period of time may be selected to extend until an end of a time period over which the system information is transmitted). In some examples, the resources may include a channel of the shared radio frequency spectrum. Because the channel reservation signal is transmitted from the WLAN radio 505-h and may be formatted using a protocol or protocols understood by Wi-Fi nodes, the channel reservation signal may be more likely to succeed in reserving the shared radio frequency spectrum (at least with respect to Wi-Fi nodes) than a channel reservation signal transmitted from the WWAN radio 505-g.

In some examples, the system information manager 825 may be used to manage the monitoring of resources of the shared radio frequency spectrum. The resources may be monitored for the system information to which the received timing information pertains. The shared radio frequency spectrum may be monitored using the WWAN radio 505-g. The monitoring may be performed independent of a successful reservation of the resources of the shared radio frequency spectrum by the WLAN radio 505-h.

In some examples, the UE 115-j may receive system information on a plurality of occasions or in a periodic manner. For example, the UE 115-j may receive system information during each of a plurality of CET periods of a base station, as described, for example, with reference to FIG. 4.

In some examples, the UE 115-i, WWAN radio 505-g, and WLAN radio 505-h may be used to perform various of the additional operations performed by the UEs 115, WWAN radios 505, and WLAN radios 505 described with reference to FIGS. 5-7, which for the sake of brevity will not be repeated.

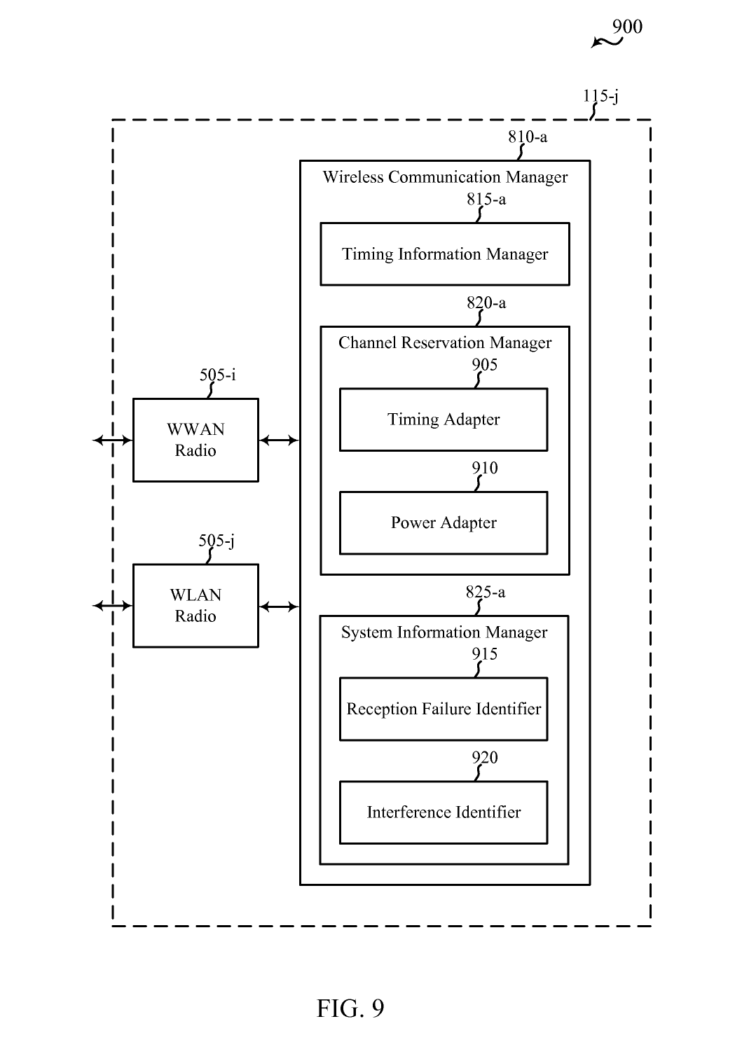

FIG. 9 shows a block diagram 900 of an apparatus 115-j for use in wireless communication, in accordance with various aspects of the present disclosure. In some examples, the apparatus 115-j may be an example of aspects of the UEs 115 described with reference to FIGS. 1-3 and 5-7, or aspects of the apparatus 115-i described with reference to FIG. 8. The apparatus 115-j may also be or include a processor (not shown). The apparatus 115-j may include a WWAN radio 505-i, a WLAN radio 505-j, and/or a wireless communication manager 810-a. Each of these components may be in communication with each other.

The apparatus 115-j, through the WWAN radio 505-i, the WLAN radio 505-j, and/or the wireless communication manager 810-a, may perform functions described herein. In some examples, the WWAN radio 505-i, WLAN radio 505-j, and wireless communication manager 810-a may be respective examples of the WWAN radio 505-g, WLAN radio 505-h, and wireless communication manager 810 described with reference to FIG. 8. Similarly, the timing information manager 815-a, channel reservation manager 820-a, and system information manager 825-a may be respective examples of the timing information manager 815, channel reservation manager 820, and system information manager 825 described with reference to FIG. 8.

As shown in FIG. 9, the channel reservation manager 820-a may include an optional timing adapter 905 or power adapter 910. The timing adapter 905 may be used to adapt the transmission timing of a signal to reserve resources of the shared radio frequency spectrum, upon the channel reservation manager 820-a determining a failure of the WLAN radio 505-j to reserve the resources of the shared radio frequency spectrum, as described with reference to FIG. 7. The power adapter 910 may be used to adapt the transmit power of a signal to reserve resources of the shared radio frequency spectrum, upon the system information manager 825-a identifying at least one of: a failure to receive at least one transmission of system information at the WWAN radio 505-i, or a threshold level of interference with at least one transmission of system information, or a combination thereof, as described with reference to FIG. 6. In some embodiments, the channel reservation manager 820-a may include one or the other of the timing adapter 905 or power adapter 910.

As also shown in FIG. 9, the system information manager 825-a may include an optional reception failure identifier 915 or interference identifier 920. The reception failure identifier 915 may be used to identify a failure to receive at least one reception of system information at the WWAN radio 505-i and trigger at least one of: a passing of timing information from the timing information manager 815-a to the WLAN radio 505-j; activation of the channel reservation manager 820-a; or use of the power adapter 910 by the channel reservation manager 820-a, as described with reference to FIGS. 6 and 7. Similarly, the interference identifier 920 may be used to identify a threshold level of interference with at least one reception of system information at the WWAN radio 505-i and trigger at least one of: a passing of timing information from the timing information manager 815-a to the WLAN radio 505-j; activation of the channel reservation manager 820-a; or use of the power adapter 910 by the channel reservation manager 820-a, as described with reference to FIGS. 7 and 8.

In some examples, the UE 115-j, WWAN radio 505-i, and WLAN radio 505-j may be used to perform various additional operations performed by the UEs 115, WWAN radios 505, and WLAN radios 505 described with reference to FIGS. 5-7.

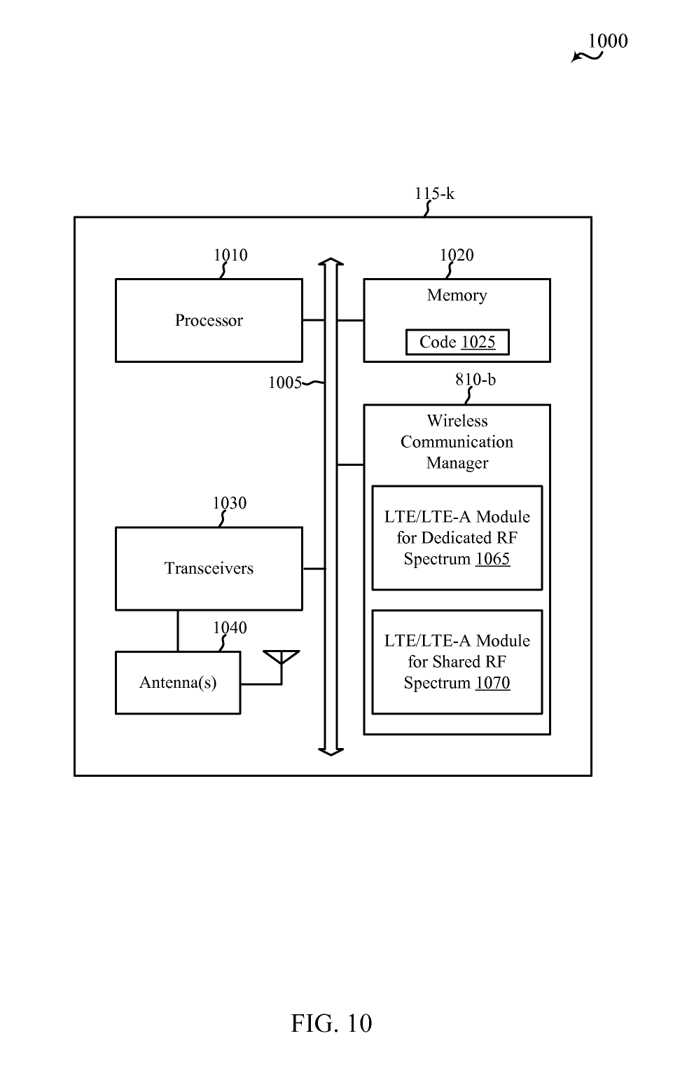

Turning to FIG. 10, a block diagram 1000 of a UE 115-k for use in wireless communication is shown, in accordance with various aspects of the present disclosure. The UE 115-k may have various configurations and may be included or be part of a personal computer (e.g., a laptop computer, a netbook computer, a tablet computer, etc.), a cellular telephone, a PDA, a digital video recorder (DVR), an internet appliance, a gaming console, an e-reader, etc. The UE 115-k may, in some examples, have an internal power supply (not shown), such as a small battery, to facilitate mobile operation. In some examples, the UE 115-k may be an example of aspects of the UEs or apparatuses 115 described with reference to FIGS. 1-3 and 5-10. The UE 115-k may be implement at least some of the UE or apparatus features and functions described with reference to FIGS. 1-10.

The UE 115-k may include a processor 1010, a memory 1020, radios 1030, at least one antenna (represented by antenna(s) 1040), or a wireless communication manager 810-b. Each of these components may be in communication with each other, directly or indirectly, over at least one bus 1005.

The memory 1020 may include random access memory (RAM) or read-only memory (ROM). The memory 1020 may store computer-readable, computer-executable code 1025 containing instructions that, when executed, cause the processor 1010 to perform various functions described herein related to wireless communication over a shared radio frequency spectrum. Alternatively, the code 1025 may not be directly executable by the processor 1010 but cause the UE 115-k (e.g., when compiled and executed) to perform various functions described herein.

The processor 1010 may include an intelligent hardware device, e.g., a central processing unit (CPU), a microcontroller, an ASIC, etc. The processor 1010 may process information received through the radios 1030 or information to be sent to the radios 1030. The processor 1010 may handle, alone or in connection with the wireless communication manager 810-b, various aspects of communicating over (or managing communications over) a dedicated radio frequency spectrum or a shared radio frequency spectrum. The dedicated radio frequency spectrum may include a radio frequency spectrum for which transmitting apparatuses may not contend for access (e.g., a radio frequency spectrum licensed to particular users for particular uses, such as a licensed radio frequency spectrum usable for LTE/LTE-A communications). The shared radio frequency spectrum may include a radio frequency spectrum for which transmitting apparatuses may need to contend for access (e.g., a radio frequency spectrum that is available for unlicensed use, such as Wi-Fi use, or a radio frequency spectrum that is available for use by multiple operators in an equally shared or prioritized manner).

The radios 1030 may include a WWAN radio and a WLAN radio. Each radio may include or be associated with a modem that modulates packets and provide the modulated packets to the antenna(s) 1040 for transmission, and to demodulate packets received from the antenna(s) 1040. The radios 1030 may, in some examples, be implemented as at least one radio transmitter and at least one separate radio receiver. The radios 1030 may support communications in the licensed radio frequency spectrum or the unlicensed radio frequency spectrum. A WWAN radio may communicate bi-directionally, via the antenna(s) 1040, with at least one of the base stations 105 described with reference to FIGS. 1-3 and 5-7. A WLAN radio may communicate bi-directionally, via the antenna(s) 1040, with at least one of the Wi-Fi nodes 305 described with reference to FIGS. 3 and 5-7. While the UE 115-k may include a single UE antenna, there may be examples in which the UE 115-k may include multiple UE antennas 1040.

The wireless communication manager 810-b may perform or control some or all of the UE or apparatus features or functions described with reference to FIGS. 1-9 and related to wireless communication over the dedicated radio frequency spectrum or the shared radio frequency spectrum. For example, the wireless communication manager 810-b may support a supplemental downlink mode (e.g., a licensed assisted access mode), a carrier aggregation mode, or a standalone mode using the dedicated radio frequency spectrum or the shared radio frequency spectrum. The wireless communication manager 810-b may include an LTE/LTE-A module for dedicated RF spectrum 1065 to handle LTE/LTE-A communications in the dedicated radio frequency spectrum, and an LTE/LTE-A module for shared RF spectrum 1070 to handle LTE/LTE-A communications in the shared radio frequency spectrum. The wireless communication manager 810-b, or portions of it, may include a processor, or some or all of the functions of the wireless communication manager 810-b may be performed by the processor 1010 or in connection with the processor 1010. In some examples, the wireless communication manager 810-b may be an example of the wireless communication manager 810 described with reference to FIGS. 8 and 9.

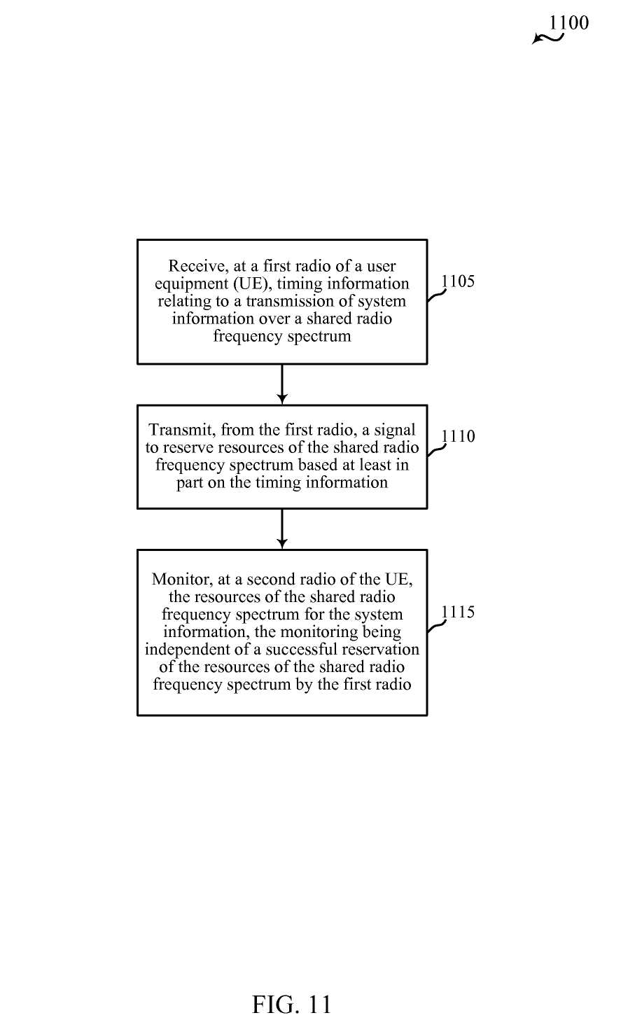

FIG. 11 is a flow chart illustrating an example of a method 1100 for wireless communication, in accordance with various aspects of the present disclosure. For clarity, the method 1100 is described below with reference to aspects of the UEs or apparatuses 115 described with reference to FIGS. 1-3 and 5-10. In some examples, a UE may execute sets of codes to control the functional elements of the UE to perform the functions described below. Additionally or alternatively, the UE may perform the functions described below using special-purpose hardware.

At block 1105, the method 1100 may include receiving, at a first radio of a UE, timing information relating to a transmission of system information over a shared radio frequency spectrum. In some examples, the timing information may identify at least one time period over which the system information is transmitted. In some examples, the first radio may include a WLAN radio. At block 1110, the method 1100 may include transmitting, from the first radio, a signal to reserve resources of the shared radio frequency spectrum based at least in part on the timing information. The transmitted signal may include, for example, a CTS-to-Self signal (e.g., a CTS-to-self signal having a NAV set to reserve the resources of the shared radio frequency spectrum for a predetermined period of time, which predetermined period of time may be selected to extend until an end of a time period over which the system information is transmitted). In some examples, the resources may include a channel of the shared radio frequency spectrum. At block 1115, the method 1100 may include monitoring, at a second radio of the UE, the resources of the shared radio frequency spectrum for the system information. The monitoring may be performed independent of a successful reservation of the resources of the shared radio frequency spectrum by the first radio. In some examples, the second radio may include a WWAN radio.

The operations at blocks 1105, 1110, and 1115 may be performed using the wireless communication manager 810 described with reference to FIGS. 8-10.

Thus, the method 1100 may provide for wireless communication. It should be noted that the method 1100 is just one implementation and that the operations of the method 1100 may be rearranged or otherwise modified such that other implementations are possible.

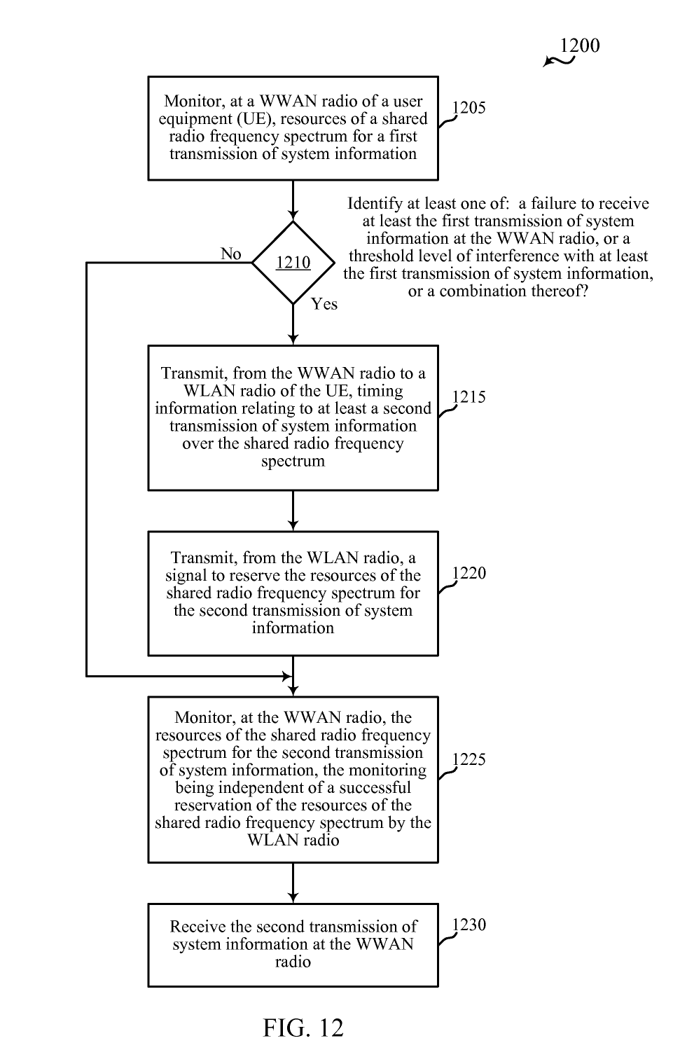

FIG. 12 is a flow chart illustrating an example of a method 1200 for wireless communication, in accordance with various aspects of the present disclosure. For clarity, the method 1100 is described below with reference to aspects of the UEs or apparatuses 115 described with reference to FIGS. 1-3 and 5-10. In some examples, a UE may execute sets of codes to control the functional elements of the UE to perform the functions described below. Additionally or alternatively, the UE may perform the functions described below using special-purpose hardware.

At block 1205, the method 1200 may include monitoring, at a WWAN radio of a UE, resources of a shared radio frequency spectrum for a first transmission of system information.

At block 1210, the method 1200 may include determining whether there exists at least one of a failure to receive at least the first transmission of system information at the WWAN radio, a threshold level of interference with at least the first transmission of system information, or a combination thereof. Upon identifying one of these events, the method 1200 may continue at block 1215. Otherwise, the method 1200 may continue at block 1225.

At block 1215, the method 1200 may include transmitting, from the WWAN radio to a WLAN radio of the UE, timing information relating to a transmission of system information over the shared radio frequency spectrum. In some examples, the timing information may identify at least one time period over which the system information is transmitted.

At block 1220, the method 1200 may include transmitting, from the WLAN radio, a signal to reserve resources of the shared radio frequency spectrum for the second transmission of system information. The signal may be based at least in part on the identification made at block 1210 and at least in part on the timing information transmitted at block 1215. In some examples, the transmitted signal may include a CTS-to-Self signal. A NAV of the CTS-to-Self signal may be set to reserve the resources of the shared radio frequency spectrum for a predetermined period of time. In some examples, the method 1200 may include selecting the predetermined period of time to extend until an end of a time period over which the second transmission of system information is transmitted. In some examples, the resources may include a channel of the shared radio frequency spectrum.

At block 1225, the method 1200 may include monitoring, at the WWAN radio, the resources of the shared radio frequency spectrum for the second transmission of system information. The monitoring may be performed independent of a successful reservation of the resources of the shared radio frequency spectrum by the WLAN radio.

At block 1230, the method 1200 may include receiving the second transmission of system information at the WWAN radio.

The operations at blocks 1205, 1210, 1215, 1220, 1225, and 1230 may be performed using the wireless communication manager 810 described with reference to FIGS. 8-10.

Thus, the method 1200 may provide for wireless communication. It should be noted that the method 1200 is just one implementation and that the operations of the method 1200 may be rearranged or otherwise modified such that other implementations are possible.

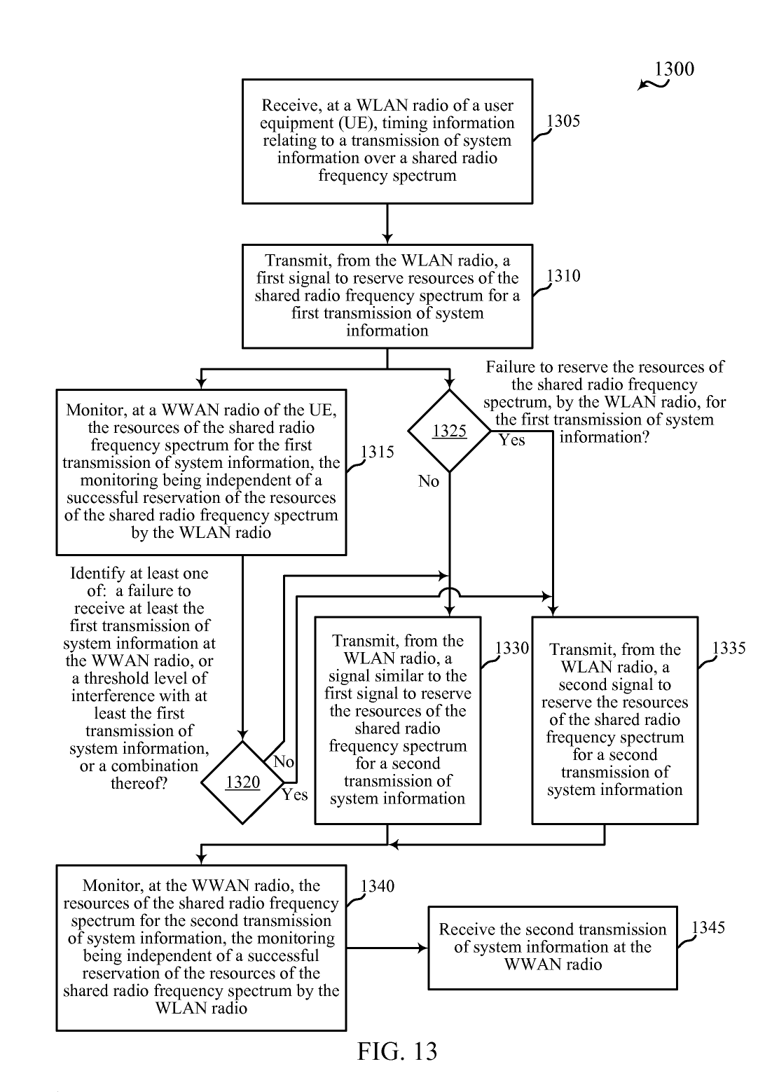

FIG. 13 is a flow chart illustrating an example of a method 1300 for wireless communication, in accordance with various aspects of the present disclosure. For clarity, the method 1100 is described below with reference to aspects of the UEs or apparatuses 115 described with reference to FIGS. 1-3 and 5-10. In some examples, a UE may execute sets of codes to control the functional elements of the UE to perform the functions described below. Additionally or alternatively, the UE may perform the functions described below using special-purpose hardware.

At block 1305, the method 1300 may include receiving, at a WLAN radio of a UE, timing information relating to a transmission of system information over a shared radio frequency spectrum. In some examples, the timing information may identify at least one time period over which the system information is transmitted.

At block 1310, the method 1300 may include transmitting, from the WLAN radio, a first signal to reserve resources of the shared radio frequency spectrum for a first transmission of system information. The first signal may be based at least in part on the timing information transmitted at block 1310. In some examples, the first signal may include a CTS-to-Self signal. A NAV of the CTS-to-Self signal may be set to reserve the resources of the shared radio frequency spectrum for a predetermined period of time. In some examples, the method 1300 may include selecting the predetermined period of time to extend until an end of a time period over which the first transmission of system information is transmitted. In some examples, the resources may include a channel of the shared radio frequency spectrum.

Following the operation(s) performed at block 1310, the method 1300 may include performing the operations at blocks 1315 and 1325. At block 1315, the method 1300 may include monitoring, at a WWAN radio of the UE, the resources of the shared radio frequency spectrum for the first transmission of system information. The monitoring may be performed independent of a successful reservation of the resources of the shared radio frequency spectrum by the WLAN radio.

At block 1320, the method 1300 may include determining whether there exists at least one of a failure to receive at least the first transmission of system information at the WWAN radio, a threshold level of interference with at least the first transmission of system information, or a combination thereof. Upon identifying one of these events, the method 1300 may continue at block 1335. Otherwise, the method 1300 may continue at block 1330.

At block 1325, the method 1300 may include determining whether there was a failure to reserve the resources of the shared radio frequency spectrum, by the WLAN radio, for the first transmission of system information. Upon determining there was failure to reserve the resources, the method 1300 may continue at block 1335. Otherwise, the method 1300 may continue at block 1330.

At block 1330, the method 1300 may include transmitting, from the WLAN radio, a signal similar to the first signal to reserve the resources of the shared radio frequency spectrum for a second transmission of system information. The signal may be based at least in part on the timing information transmitted at block 1305.

At block 1335, the method 1300 may include transmitting, from the WLAN radio, a second signal to reserve the resources of the shared radio frequency spectrum for the second transmission of system information. The signal may be based at least in part on the timing information transmitted at block 1305. However, in contrast to the first signal, and in some examples, the second signal may be transmitted earlier with respect to transmission of the second transmission of system information than the first signal was transmitted with respect to transmission of the first transmission of system information. Also or alternatively, the second signal may have a higher transmit power than the first signal.

At block 1340, the method 1300 may include monitoring, at the WWAN radio, the resources of the shared radio frequency spectrum for the second transmission of system information. The monitoring may be performed independent of a successful reservation of the resources of the shared radio frequency spectrum by the WLAN radio.

At block 1345, the method 1300 may include receiving the second transmission of system information at the WWAN radio.

The operations at blocks 1305, 1310, 1315, 1320, 1325, 1330, 1335, and 1340 may be performed using the wireless communication manager 810 described with reference to FIGS. 8-10.

Thus, the method 1300 may provide for wireless communication. It should be noted that the method 1300 is just one implementation and that the operations of the method 1300 may be rearranged or otherwise modified such that other implementations are possible.

In some examples, aspects of two or more of the methods 1100, 1200, and 1300 described with reference to FIGS. 11, 12, and 13 may be combined.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted as instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
receiving, at a first radio of a user equipment (UE), timing information relating to a transmission of system information over a shared radio frequency spectrum;
transmitting, from the first radio, a signal to reserve resources of the shared radio frequency spectrum based at least in part on the timing information; and
monitoring, at a second radio of the UE, the resources of the shared radio frequency spectrum for the system information, the monitoring being independent of a successful reservation of the resources of the shared radio frequency spectrum by the first radio.

2. The method of claim 1, wherein the signal to reserve resources of the shared radio frequency spectrum comprises a clear to send (CTS)-to-Self signal.

3. The method of claim 2, further comprising:
setting a network allocation vector (NAV) of the CTS-to-Self signal to reserve the resources of the shared radio frequency spectrum for a predetermined period of time.

4. The method of claim 1, further comprising:
receiving a plurality of transmissions of system information at the second radio.

5. The method of claim 4, further comprising:
identifying a failure to receive at least a first transmission of system information at the second radio or a threshold level of interference with at least the first transmission of system information or a combination thereof; and
transmitting, from the first radio, the signal to reserve resources of the shared radio frequency spectrum for a second transmission of system information based at least in part on the identifying.

6. The method of claim 4, wherein the signal to reserve resources of the shared radio frequency spectrum comprises a first signal transmitted for a first transmission of system information, the method further comprising:
determining a failure to reserve the resources of the shared radio frequency spectrum, by the first radio, for the first transmission of system information; and
transmitting, from the first radio, a second signal to reserve resources of the shared radio frequency spectrum, the second signal being transmitted earlier with respect to transmission of the second transmission of system information than the first signal was transmitted with respect to transmission of the first transmission of system information.

7. The method of claim 4, wherein the signal to reserve resources of the shared radio frequency spectrum comprises a first signal transmitted for a first transmission of system information, the method further comprising:
identifying a failure to receive at least the first transmission of system information at the second radio or a threshold level of interference with at least the first transmission of system information or a combination thereof; and
transmitting, from the first radio, a second signal to reserve resources of the shared radio frequency spectrum, the second signal has a higher transmit power than the first signal.

8. The method of claim 1, wherein receiving the timing information at the first radio comprises:
receiving the timing information from the second radio.

9. The method of claim 1, wherein the timing information identifies at least one time period over which the system information is transmitted, the method further comprising:
selecting a predetermined period of time to extend until an end of a time period over which the system information is transmitted.

10. The method of claim 1, wherein the resources of the shared radio frequency spectrum comprise a channel of the shared radio frequency spectrum.

11. The method of claim 1, wherein the first radio comprises a wireless local area network (WLAN) radio, and wherein the second radio comprises a wireless wide area network (WWAN) radio.

12. The method of claim 1, wherein the system information is received from a base station during a clear channel assessment (CCA)-exempt transmission (CET) period of the base station.

13. An apparatus for wireless communication, comprising:
a first radio to receive timing information relating to a transmission of system information over a shared radio frequency spectrum, and to transmit a signal to reserve resources of the shared radio frequency spectrum based at least in part on the timing information; and
a second radio to monitor the resources of the shared radio frequency spectrum for the system information independent of a successful reservation of the resources of the shared radio frequency spectrum by the first radio.

14. The apparatus of claim 13, wherein the signal to reserve resources of the shared radio frequency spectrum comprises a clear to send (CTS)-to-Self signal.

15. The apparatus of claim 14, further comprising:
a channel reservation manager to set a network allocation vector (NAV) of the CTS-to-Self signal to reserve the resources of the shared radio frequency spectrum for a predetermined period of time.

16. The apparatus of claim 13, wherein the second radio receives a plurality of transmissions of system information.

17. The apparatus of claim 16, further comprising:
a system information manager to identify a failure to receive at least a first transmission of system information at the second radio or a threshold level of interference with at least the first transmission of system information or a combination thereof;
wherein the first radio transmits the signal to reserve resources of the shared radio frequency spectrum for a second transmission of system information based at least in part on an identification of the failure to receive or the threshold level of interference identified by the system information manager.

18. The apparatus of claim 16, wherein the signal to reserve resources of the shared radio frequency spectrum comprises a first signal transmitted for a first transmission of system information to the apparatus, the apparatus further comprising:
a channel reservation manager to determine a failure to reserve the resources of the shared radio frequency spectrum, by the first radio, for the first transmission of system information;
a timing adapter to adapt a transmission timing of a second signal to reserve resources of the shared radio frequency spectrum;
wherein the first radio transmits the second signal to reserve the resources of the shared radio frequency spectrum, the second signal being transmitted earlier with respect to transmission of the second transmission of system information than the first signal was transmitted with respect to transmission of the first transmission of system information.

19. The apparatus of claim 13, wherein the first radio comprises a wireless local area network (WLAN) radio, and wherein the second radio comprises a wireless wide area network (WWAN) radio.

20. An apparatus for wireless communication, comprising:
means for receiving, at a first radio, timing information relating to a transmission of system information over a shared radio frequency spectrum;
means for transmitting, from the first radio, a signal to reserve resources of the shared radio frequency spectrum based at least in part on the timing information; and
means for monitoring, at a second radio, the resources of the shared radio frequency spectrum for the system information, the monitoring being independent of a successful reservation of the resources of the shared radio frequency spectrum by the first radio.
